(19) United States
(12) Patent Application Publication
(10) Pub. No.: US 2014/0279241 A1
(43) Pub. Date: Sep. 18, 2014

(54) Electronic Product Information Retrieval Environment

(71) Applicants: Aaron Robert Bartholomew, Noel, MO (US); Alvin Scott Taulbee, Springdale, AR (US); Derric D'Souza, Bentonville, AR (US); William Hogg, Rogers, AR (US); Venkata Subba Reddy Bagepalli, Bentonville, AR (US)

(72) Inventors: Aaron Robert Bartholomew, Noel, MO (US); Alvin Scott Taulbee, Springdale, AR (US); Derric D'Souza, Bentonville, AR (US); William Hogg, Rogers, AR (US); Venkata Subba Reddy Bagepalli, Bentonville, AR (US)

(73) Assignee: Wal-Mart Stores, Inc., Bentoville, AR (US)

(21) Appl. No.: 13/827,628

(22) Filed: Mar. 14, 2013

(51) Int. Cl. G06Q 30/06

(52) U.S. Cl. CPC G06Q 30/0623
USPC 705/26.61

(57) ABSTRACT

Exemplary embodiments are directed to providing product information from disparate sources in an electronic product information retrieval environment. An electronic product search request can be received from a user and product specific information returned in response to the search request can be used by exemplary embodiments to programmatically constructs one or more electronic requests for information from one or more disparate data sources to retrieve inventory information, logistic information, and/or product location information corresponding the products identified in the product specific information. A graphical user interface can be generated by exemplary embodiments providing an integrated and formatted view of the product specific information, the inventory information, and the product location information for display.

### BACKGROUND

Conventionally, retail entities maintain product information corresponding to products sold by the retail entity. In some instances, employees working at a specific retail location can access certain product information using enterprise software programs that interface with data sources. These conventional software programs may be developed for a specific purpose, such as monitoring product inventory. In addition, many retail entities allow users and employees to access product information through websites of the retail entities. These websites typically allow users to search for product specific information, such as a product description, image, and price. Some websites are also programmed to provide a user with the quantity of a product remaining at a store without specific reference to an actual location of the product in the store (e.g., whether the product in on a display shelf in the store or is the stock room).

Conventionally, retail entities have different enterprise software programs for different types of product information and the product information can be distributed across different data sources. Maintaining product information in different data sources can result in an inability to provide an employee or customer with comprehensive product information in response to search using the enterprise software programs and/or the website of a retail entity.

### SUMMARY

Exemplary embodiments of the present disclosure are directed to providing product information from disparate data sources in an electronic product information retrieval environment. An electronic product search request can be received from a user and product specific information returned in response to the search request can be used by exemplary embodiments to programmatically construct one or more electronic requests for information from one or more disparate data sources to retrieve additional product information corresponding the products identified in the product specific information. The product information received in response to the searches can be compiled and formatted to be presented to the user in a graphical user interface generated by exemplary embodiments.

In one embodiment, in an electronic commerce environment, a computer-implemented method of providing product information from disparate sources in an integrated graphical format is disclosed. The method includes receiving an electronic product search request including search parameters from a user though an electronic device in communication with a data communications network, searching a first electronic data source in response to the search request to programmatically identify product specific information that corresponds to one or more products associated with the search parameters in the search request, programmatically constructing an electronic product inventory search request using the product specific information, and searching a second electronic data source for inventory information of the one or more products in response to the product inventory search request to programmatically identify whether the one or more products are available. The method also includes programmatically constructing an electronic product location search request automatically from the product specific information and the inventory information, searching a third electronic data source for product location information of the one or more products in response to the product inventory search request to programmatically identify a location of the one or more products, and forwarding instructions and data to a graphical user interface for display by the electronic device having executable code to integrate the product specific information from the first electronic data source, the inventory information from the second electronic data source, and the product location information from the third electronic data source for display by the electronic device.

In another embodiment, a non-transitory computer-readable storage device configured to store instructions executable by a processing device is disclosed. Execution of the instructions in an electronic product information retrieval environment causes the processing device to implement a method of retrieving product information from disparate sources. The processing device reads instructions to receive an electronic product search request including search parameters from a user though an electronic device in communication with a data communications network, reads instructions to search a first electronic data source in response to the search request to programmatically identify product specific information that corresponds to one or more products associated with the search parameters in the search request, and reads instructions to programmatically construct an electronic product inventory search request using the product specific information. The processing device also reads instructions to search a second electronic data source for inventory information of the one or more products in response to the product inventory search request to programmatically identify whether the one or more products are available, reads instructions to programmatically construct an electronic product location search request from the product specific information and the inventory information, reads instructions to search a third electronic data source for product location information of the one or more products in response to the product inventory search request to programmatically identify a location of the one or more products, and reads instructions to forward instructions and data to a graphical user interface for display by the electronic device having executable code to integrate the product specific information from the first electronic data source, the inventory information from the second electronic data source, and the product location information from the third electronic data source for display by the electronic device.

In yet another embodiment, an electronic commerce system for providing product information from disparate sources in an integrated graphical format is disclosed. The system includes a non-transitory storage device and a processing device. The non-transitory storage device stores instructions for a front end product information retrieval system. The processing device is in communication with the non-transitory storage device to execute the instructions. Execution of the instruction by the processing device cause the processing to receive an electronic product search request including search parameters from a user though an electronic device in communication with a data communications network, programmatically submit the electronic product search request to a product search service, receive product specific information that corresponds to one or more products associated with the search parameters in the search request. The product specific information is retrieved in response to searching a first electronic data source. Execution of the instructions by the processing device also causes the processing device to programmatically construct an electronic inventory search request using the product specific information, programmatically submit the electronic inventory search request to an inventory retrieval service, and receive inventory information in response to the electronic inventory search request that corresponds to one or more products and identifies whether the one or more products are available. The inventory information is retrieved in response to searching of a second electronic data source. Execution of the instructions by the processing device causes the processing device to programmatically construct an electronic product location search request from the product specific information and the inventory information, programmatically submit the electronic product location search request to an product location service, receive product location information of the one or more products in response the electronic product location search request. The product location information is retrieved in response to searching a third electronic data source. Execution of the instructions by the processing device further causes the processing device to forward instructions and data to a graphical user interface for display by the electronic device having executable code to integrate the product specific information from the first electronic data source, the inventory information from the second electronic data source, and the product location information from the third electronic data source for display by the electronic device.

In still another embodiment, a computer-implemented method is disclosed in which a downloadable user interface executable is provided on a portable electronic device. The downloadable user interface executable provides for receiving an electronic product search request including search parameters from a user though an electronic device in communication with a data communications network, programmatically submitting the electronic product search request to a product search service, receiving product specific information that corresponds to one or more products associated with the search parameters in the search request. The product specific information is retrieved in response to searching a first electronic data source. The downloadable user interface executable provides for programmatically constructing an electronic inventory search request using the product specific information, programmatically submitting the electronic inventory search request to an inventory retrieval service, and receiving inventory information in response to the electronic inventory search request that corresponds to one or more products and identifies whether the one or more products are available. The inventory information is retrieved in response to searching of a second electronic data source. The downloadable user interface executable provides for programmatically constructing an electronic product location search request from the product specific information and the inventory information, programmatically submitting the electronic product location search request to an product location service, and receiving product location information of the one or more products in response the electronic product location search request. The product location information being retrieved in response to searching a third electronic data source. The downloadable user interface executable further provides for forwarding instructions and data to a graphical user interface for display by the electronic device having executable code to integrate the product specific information from the first electronic data source, the inventory information from the second electronic data source, and the product location information from the third electronic data source for display by the portable electronic device.

Any combination of embodiments is envisioned. Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of an exemplary product information retrieval environment in accordance with the present disclosure.

FIG. 2 is a data flow diagram of an exemplary operation of one embodiment of the environment as taught herein.

FIG. 3 is a flowchart of an exemplary product information retrieval process that can be implemented by an exemplary embodiment of the environment as taught herein.

FIG. 4 is an exemplary graphical user interface that can be provided by a user interface of an exemplary embodiment of the environment as taught herein to facilitate searching for product information and/or displaying results.

FIG. 5 is an exemplary location map that can be provided in accordance with exemplary embodiments of the present disclosure.

FIG. 6 is a block diagram of an exemplary computing device for implementing embodiments of the present disclosure.

FIG. 7 is a block diagram of an exemplary client-server environment for implementing embodiments of the resource reservation environment as taught herein.

### DESCRIPTION OF EXEMPLARY EMBODIMENTS

Exemplary embodiments of the present disclosure are directed to providing product information from disparate data sources in an electronic product information retrieval environment. An electronic product search request can be received from a user and product specific information returned in response to the search request can be used by exemplary embodiments to programmatically construct one or more electronic requests for information from one or more disparate data sources to retrieve inventory information, logistic information, and/or product location information corresponding the products identified in the product specific information. A graphical user interface can be generated by exemplary embodiments providing an integrated and formatted view of the product specific information, the inventory information, the product location information, and the logistic information for display.

In some embodiments, a computing device executing one or more applications can be used to interface with the environment. For example, the computing device can include one or more applications including executable code that can be executed to implement at least a portion of the environment on the computing device. In some embodiments, the computing device can be a portable computing device that is carried by an employee of a retail entity and/or can be a device that is carried by a customer of the retail entity.

As used herein, a “portable computing device” refers to an electronic device that is readily portable (e.g., carried and/or transported) generally having its own power source and being capable of communicating with other devices wirelessly. Some examples of portable computing device can include, but are not limited to mobile phones, tablets, laptops, internal handheld corporate devices, and/or any other suitable electronic device having its own power supply and wireless connectivity that can be carried and/or transport by a user.

FIG. 1 is a block diagram of an exemplary electronic product information retrieval environment 100 (hereinafter “environment 100”). Exemplary embodiments of the environment 100 can be implemented using hardware, software, and/or a combination thereof. For example, in one exemplary embodiment, one or more computing devices, such as one or more client devices and/or one or more servers, can be configured to implement exemplary embodiments of the environment 100. Exemplary embodiments of a client device and/or a server programmed and/or configured to implement embodiments of the environment 100, or portions thereof, is shown, for example, in FIGS. 6 and 7. The environment 100 can be programmed and/or include executable code to implement a product information retrieval process to retrieve product information in response to requests from users.

The environment 100 can include a user interface 110, a speech-to-text interface 120, speech-to-text service 125, item search interface 130, item search service 135, a stock (back) room inventory and location retrieval interface 140, stock room inventory and location service 145, an in-store inventory retrieval interface 150, in-store inventory service 155, aisle location retrieval interface 160, an aisle location service 165, and an integration engine 180. The services 125, 135, 145, 155, and 165 can be implemented as software programs and/or functions developed for a specific operation or task (e.g., converting speech to text). In exemplary embodiments, the user interface 110, the speech-to-text interface 120, the search interface 130, the stock room inventory retrieval interface 140, in-store inventory retrieval interface 150, the aisle location retrieval interface 160, and the integration engine 180 can be referred to as a front end product information retrieval system 102. In exemplary embodiments, the speech-to-text service 125, the item search service 135, the stock room inventory and location service 145, the in-store inventory retrieval service 155, and the item location service 165 can be referred to as a back end product information retrieval system 104.

In some embodiments, the front end system 102 can be implemented by a computing device including, for example, by a portable computing device. For example, the computing device, such as a device similar to the computing device of FIG. 6, can download the front end system from, for example, a website and can install the front end system 102 to utilize the environment 100. In some embodiments, the front end system 102 can loaded and installed on the computing device via one or more non-transitory computer readable computer program products. In some embodiments, the front end system can be executed remotely from the computing device by another computing device (e.g., a server) and the computing device can interact with the other device to utilize the environment 100.

In exemplary embodiments, the user interface 110 can be programmed and/or include executable code to provide one or more graphical user interfaces (GUIs) 112 through which a user can interact with the environment 100. The GUIs 112 displayed to users can include data entry areas to receive information from the user and/or can include data outputs to display information to the user. For example, one of the GUIs 112 can allow a user to enter product search parameters 114 that can be used to generate a search request and can display resources returned in response to the search request, which can incorporate product information from one or more disparate data sources. Some examples of data entry fields include, but are not limited to text boxes, check boxes, buttons, dropdown menus, and/or any other suitable data entry fields. The search parameters 114 can be passed to the search interface 130 for further processing.

In exemplary embodiments, the search parameters 114 can be specified by a user and/or environment 100. For example, in exemplary embodiments, the search parameters 114 can include search terms (e.g., keywords, product identifiers (including sku numbers, model numbers, etc)), a store identifier, a zip code to find the closest store locations, as well as other resource parameters. In some embodiments, the user interface 110 can be programmed and/or include executable code to specify some of the search parameters 114 and/or to restrict a user's entries to choices specified by the user interface 110. In one embodiment, the user interface 110 can be programmed and/or include executable code to restrict a user's entries based on whether the user is a customer of a retail entity or an employee of the retail entity.

In exemplary embodiments, the user interface 110 can be programmed and/or configured to permit a user to scan an encoded identifier, such as, for example, a bar code, a quick response code (QR code), electronic product code (e.g., a radio frequency identification tag) located on or associated with a product, and/or any other suitable encoded identifiers suitable for use as input for search parameters 114. Upon scanning the encoded identifier, the user interface 110 can display information returned by the environment 100 that is related to the product, similar products, alternative products, and/or related products including, for example, an availability of the product in the retail entity, information about a location of the product in the retail entity, a price of the product, one or more images of the product, a description of the product, and/or any other suitable product information.

In exemplary embodiments, the user interface 110 can be programmed and/or configured to receive search parameters 114 as speech from a user. Upon receiving the spoken search parameters 114, the user interface 110 can display information returned by the environment 100 that is related to one or more products corresponding to the search parameters including, for example, an availability of the product in the retail entity, information about a location of the product in the retail entity, a price of the product, one or more images of the product, a description of the product, and/or any other suitable product information.

The speech-to-text interface 120 can be programmed and/or include executable code to provide an interface between the user interface 110 and the speech-to-text service 125 to facilitate initiating speech-to-text conversion. In exemplary embodiments, the speech-to-text interface 120 can be programmed to receive digitized spoken search parameters from the user interface 110 and can submit the digitized spoken search parameters to the speech-to-text service 125. The speech-to-text interface 120 can receive textual data corresponding to the digitized spoken search parameters from the service 125, which can be used by the environment 100 to create a search request.

The speech-to-text service 125 can receive digital speech from the speech-to-text interface 120 and can be programmed and/or configured to convert the digitized speech into textual data corresponding to the digitized speech. For example, the speech-to-text service 125 can parse the digitized speech and can retrieve corresponding textual data from a speech-to-text data source, such as a speech-to-text data library or database. The speech-to-text service 125 can be programmed and/or configured to return the textual data to the speech-to-text interface 120, which can be programmed to provide the textual data to the item search interface 130 for further processing, as described in more detail below.

The item search interface 130 can be programmed and/or configured to provide an interface between the user interface 110 and/or the speech-to-text interface and the item search service 135 to facilitate searching for product specific information (i.e., information about the product itself). The item search interface 130 can also be programmed and/or configured to provide an interface between the item search interface 130 and the integration engine 180. In exemplary embodiments, the item search interface 130 can be programmed to pass the search parameters 114 to the item search service 135 and to receive product specific information from the item search service 135. The item search interface 130 can be programmed and/or configured to pass the product specific information to the integration engine 180.

The item search service 135 can be programmed and/or configured to search for product specific information corresponding to the search parameters in the search request. For example, the item search service 135 can be programmed and/or configured to create a query from the search parameters in the search request to retrieve product specific information from a data source, such as a database storing the product specific information. The product specific information retrieved by the item search service can include, for example, product names, product descriptions, product prices, and product images.

The stock room inventory and location retrieval interface 140 can be programmed and/or include executable code to provide an interface between the integration engine 180 and the stock room inventory and location retrieval service 145. The stock room inventory and location retrieval interface 140 can receive a product identifier and a store identifier in a request received from the integration engine 180. The stock room inventory and location retrieval interface 140 can pass the product identifier and the store identifier to the stock room inventory and location retrieval service 145. Inventory information retrieved by the stock room inventory and location retrieval service 145 can be returned to the stock room inventory and location retrieval interface 140, which can pass the stock room inventory and location information to the integration engine 180.

The inventory and location retrieval service 145 can be programmed and/or configured to search for inventory information corresponding to the product identifier and store identifier provided by the inventory and location retrieval interface 140. For example, the inventory and location retrieval service 145 can be programmed and/or configured to construct a query using the product identifier and store identifier to retrieve the inventory and location information from a data source, such as a database storing the inventory and location information. The inventory and location information retrieved by the inventory and location retrieval service can include, for example, a quantity of products in the stock room and/or a location of the products in the stock room. In some embodiments, the stock room inventory and location information can be restricted to employees such that customers utilizing the environment 100 cannot access the stock room inventory and location information. In some embodiments, the stock room inventory and location information can be unrestricted such that employees and customers utilizing the environment 100 can access the stock room inventory and location information.

The in-store inventory retrieval interface 150 can be programmed and/or include executable code to provide an interface between the integration engine 180 and the in-store inventory retrieval service 155. The in-store inventory retrieval interface 150 can receive a product identifier and a store identifier in a request received from the integration engine 180. The in-store inventory retrieval interface 150 can pass the product identifier and the store identifier to the in-store inventory retrieval service 155. In-store inventory information retrieved by the in-store inventory retrieval service 155 can be returned to the in-store inventory retrieval interface 150, which can pass the in-store inventory and location information to the integration engine 180.

The in-store inventory retrieval service 155 can be programmed and/or configured to search for in-store inventory information corresponding to the product identifier and store identifier provided by the in-store inventory retrieval interface 150. For example, the in-store inventory retrieval service 155 can be programmed and/or configured to construct a query using the product identifier and store identifier to retrieve the in-store inventory information from a data source, such as a database storing the in-store inventory information. The in-store inventory information retrieved by the in-store inventory retrieval service 155 can include, for example, a total quantity of products in the store.

The aisle location retrieval interface 160 can be programmed and/or include executable code to provide an interface between the integration engine 180 and the aisle location retrieval service 165. The aisle location retrieval interface 160 can receive one or more product identifier and a store identifier in a request received from the integration engine 180. The aisle location retrieval interface 160 can pass the one or more product identifiers and the store identifier to the aisle location retrieval service 165. Aisle location information retrieved by the aisle location retrieval service 165 can be returned to the aisle location retrieval interface 150, which can pass the aisle location information to the integration engine 180.

The aisle location service 165 can be programmed and/or configured to search for aisle location information corresponding to the one or more product identifiers and the store identifier provided by the aisle location retrieval interface 160. For example, the aisle location service 165 can be programmed and/or configured to create a query using the one or more product identifiers and the store identifier to retrieve the aisle location information from a data source, such as a database storing the aisle location information. The aisle location information retrieved by the aisle location service 165 can include, for example, a specific aisle location in a specific store location where the products can be found.

The logistic information retrieval interface 170 can be programmed and/or include executable code to provide an interface between the integration engine 180 and the logistic information service 175. The logistic information interface 170 can receive a product identifier and a store identifier in a request received from the integration engine 180. The logistic interface 150 can pass the product identifier and the store identifier to the logistic information service 175. Logistic information retrieved by the logistic information service 175 can be returned to the logistic information interface 170, which can pass the logistic information to the integration engine 180.

The logistic service 175 can be programmed and/or configured to search for logistic information corresponding to the product identifier and store identifier provided by the logistic information interface 150. For example, the logistic information service 175 can be programmed and/or configured to construct a query using the product identifier and store identifier to retrieve the logistic information from a data source, such as a database storing the logistic information. The logistic information retrieved by the logistic information service 155 can include, for example, a delivery information, routing information, ordering information, backorder information, and the like associated with one or more products associated with the product identifier.

The integration engine 180 can be programmed and/or configured to receive product information in response to a search by the item search service and can automatically generate one or more requests to obtain store specific product information from one or more data sources. For example, the integration engine 180 can programmatically generate a request for inventory information that can be processed by the inventory retrieval service 145, and programmatically generate a request for location information that can be processed by the item location service 155.

In exemplary embodiments, the integration engine 180 can format the information received from one or more of the disparate data source (e.g., S1-S5) using one or more formatting routines or functions specific to the information returned from each of the data sources, which may format and/or present the information differently from each other. The integration engine 180 can generate and format an integrated graphical user interface that can include the information from each of the data sources and can pass the GUI to the user interface for display. In one embodiment, the integration engine 180 can be programmed and/or configured to use a template for arranging the information in the GUI so that results from searches have a consistent appearance.

While the present embodiment shows the speech-to-text interface 120, the stock room inventory and location retrieval interface 140, the in-store inventory retrieval interface 150, the aisle location retrieval interface 160, the logistic information interface 170, and the integration engine 180 as being implemented separate from the user interface 110, those skilled in the art will recognize that the speech-to-text interface 120, the stock room inventory and location retrieval interface 140, the in-store inventory retrieval interface 150, the aisle location retrieval interface 160, the logistic information interface 160, and the integration engine 180 can be integrated with and/or can be a component of the user interface 110.

FIG. 2 is a data flow diagram 200 of an exemplary operation of one embodiment of the environment 100. A user can submit search parameters using the user interface, as shown by arrow 202. As one example, in one embodiment, the search parameters can be submitted as speech by a user via the user interface 110 operating in connection with a data entry device (e.g., a microphone). As another example, the user can submit search parameters by entering text into data entry fields of the GUI 112 of the user interface 110 via a data entry device (e.g., a keyboard, touchscreen, etc.). As yet another example, the user can submit search parameters by scanning or capturing an image of a product identifier associated with a product. As yet another example, the search parameters can be submitted as a combination of speech by the user, text entered into the GUI 112 by the user, and/or images captured by the user.

When the search parameters are received by the user interface 110 as speech from the user, a digitized version of the speech is passed to the speech-to-text interface 120, as shown by arrow 204, which interfaces with and calls the speech-to-text service 125, as shown by arrow 204, to pass the digitized speck to the service 125. The speech-to-text service 125 can process the digitized speech to convert the digitized speech to textual data. To convert the digitized speech to textual data, the speech-to-text service can be programmed and/or configured to construct one or more queries including data elements associated with the digitized speech. The service 125 can be programmed and/or configured to submit the one or more queries to a data source S1, such as a database that include textual data corresponding to the data elements, as shown by arrow 206. The data source can return the textual data to the service 125 in a response, as shown by arrow 208 and the service 125 can construct a response to the speech-to-text interface 120 that includes the textual elements, as shown by arrow 210. The speech-to-text interface 120 can pass the textual data to the user interface, as shown by arrow 212, to be displayed by a GUI of the user interface 110 to allow the user to determine whether the speech was correctly converted to text by the speech-to-text service 125.

In addition or alternatively to receiving speech from a user, the user can enter textual data into the GUI of the user interface 110 or can scan a product identifier (e.g., bar code, QR code) associated with the product to populate the GUI of the user interface with textual data.

The user can submit a request to the search interface 130 including the textual data, as shown by arrow 214, and the search interface 130 can generate a call to the search service 135 that includes the textual data, as shown by arrow 216. The service 135 can process the textual data and can construct one or more queries based on and in some embodiments including the textual data. The service 135 can programmatically submit the query to a data source S2, such as a database that stores product information, as shown by arrow 220, to retrieve product information that corresponds to the textual data. In response to the one or more queries, the data source S2 can provide the corresponding product information to the service 135, as shown by arrow 222, including, for example, a product name for each product being returned by the search, product identifiers, product descriptions, product prices, and product images. The service 135 can construct a response to the search interface, as shown by arrow 224, including the product information and the search interface 130 can pass the product information to the integration engine 180, as shown by arrow 226.

In response to receipt of the product information, the integration engine 180 can programmatically generate a request for stock room inventory information that can be passed to the stock room inventory retrieval interface 140, as shown by arrow 228. The inventory request can include, for example, one or more product identifiers (e.g., product name, model number, sku, etc.) received in the product information. The stock room inventory retrieval interface 140 can generate a call to the stock room inventory retrieval service 145 that includes the product identifiers, as shown by arrow 230, and the service 145 can construct and submit one or more queries to a data source S3, such as a database that includes stock room inventory information corresponding to the product identifiers, as shown by arrow 232. The data source S3 can provide the service 145 with the stock room inventory information in response to the query, as shown by arrow 234, and the service 145 can construct a response to the stock room inventory retrieval interface 140 that includes the stock room inventory information, as shown by arrow 236. The stock room inventory retrieval interface 140 can programmatically construct a response to the integration engine 180 that includes the inventory information, as shown by arrow 238.

The integration engine 180 can programmatically generate a request for in-store inventory information that can be passed to the in-store inventory retrieval interface 150, as shown by arrow 240. The inventory request can include, for example, one or more product identifiers (e.g., product name, model number, sku number, etc.) received in the product information. The in-store inventory retrieval interface 150 can generate a call to the in-store inventory retrieval service 155 that includes the product identifiers, as shown by arrow 242, and the service 155 can construct and submit one or more queries to a data source S4, such as a database that includes in-store inventory information corresponding to the product identifiers, as shown by arrow 244. The data source S4 can provide the service 155 with the in-store inventory information in response to the query, as shown by arrow 246, and the service 155 can construct a response to the in-store inventory retrieval interface 150 that includes the in-store inventory information, as shown by arrow 248. The in-store inventory retrieval interface 150 can programmatically construct a response to the integration engine 180 that includes the in-store inventory information, as shown by arrow 250.

In response to receipt of the product information and/or the inventory information, the integration engine 180 can programmatically generate a request for aisle location information that can be passed to the aisle location interface 160, as shown by arrow 252. The location request can include, for example, one or more product identifiers (e.g., product name, model number, sku number, etc.) received in the product information by the integration engine, one or more inventory identifiers (e.g., aisle number), and the store location included in the initial request. The aisle location interface 160 can generate a call to the aisle location service 165 that includes the product identifiers and/or inventory identifiers, as shown by arrow 254, and the service 165 can construct and submit one or more queries to a data source S5, such as a database that includes location information corresponding to the product identifiers, the inventory identifiers, and the store location, as shown by arrow 256. The data source S5 can provide the service 165 with the location information in response to the query, as shown by arrow 258, and the service 165 can construct a response to the location interface 160 that includes the location information, as shown by arrow 260. The location interface 160 can programmatically construct a response to the integration engine 180 that includes the location information, as shown by arrow 262.

In response to receipt of the product information, the inventory information, and/or location information, the integration engine 180 can programmatically generate a request for logistic information that can be passed to the logistic information interface 170, as shown by arrow 264. The logistic information request can include, for example, one or more product identifiers (e.g., product name, model number, sku number, etc.) received in the product information by the integration engine, one or more inventory identifiers (e.g., aisle number), and the store location included in the initial request. The logistic information interface 170 can generate a call to the logistic information service 175 that includes the product identifiers and/or inventory identifiers, as shown by arrow 266, and the service 175 can construct and submit one or more queries to a data source S6, such as a database that includes logistic information corresponding to the product identifiers, the inventory identifiers, and the store location, as shown by arrow 268. The data source S5 can provide the service 175 with the logistic information in response to the query, as shown by arrow 270, and the service 175 can construct a response to the logistic interface 170 that includes the logistic information, as shown by arrow 272. The logistic interface 170 can programmatically construct a response to the integration engine 180 that includes the logistic information, as shown by arrow 274.

Using the product information, the inventory information, the location information, and the logistic information, the integration engine 180 can generate a composite GUI, as shown by arrow 278. The integration engine 180 can generate the GUI using a template and can populate the template with the product information, the inventory information, the location information, and the logistic information. The populated template can be provided to the user interface 110 as a result of the initial request submitted by the user, which can be displayed to the user, as shown by arrow 280.

FIG. 3 is a flowchart providing an overview of an exemplary product information retrieval process. To begin, a user can submit a search request through the user interface of the environment 100 at step 300, and the environment 100 can perform a search for product specific information corresponding to search terms included in the request at step 302. For example, the user can submit a search request to the environment 100 using a computing device that interfaces with and/or executes at least a portion of the environment. The search can be limited to products sold by a specified store location of a retail entity. In step 304, the product specific information can be retrieved by the environment 100. A quantity of products returned by the environment in response to the search request can be limited to a specified number (e.g., five products). Using product identifiers retrieved by the environment 100, the environment 100 can be programmed and/or configured to automatically search for inventory information corresponding to the products returned by the search at step 306, and in step 308, the environment 100 can programmatically retrieve the inventory information including stock room inventory information and in-store inventory information. The environment 100 can be programmed and/or configured to use the product identifiers to search for aisle location information at step 310, and can retrieve the aisle location information at step 312. The environment 100 can be programmed and/or configured to use the product identifiers and store identifiers to search for logistic information at step 314, and can retrieve the logistic information at step 316. Using the product specific information, inventory information, location information, and the logistic information, the environment 100 can be programmed and/or configured to populate a graphical user interface template at step 318 and the graphical user interface can be displayed to the user in step 320. For example, the GUI can be displayed to the user on the user's computing device.

While FIGS. 2 and 3 illustrate a sequence of operations for one exemplary embodiment, those skilled in the art will recognize that the order in which the operations are performed can be changed in accordance with exemplary embodiments. Furthermore, those skilled in the art will recognize that communication between the user interface 110, integration engine 180, and the various service 125, 135, 145, 155, 165, and 175 can be performed synchronously, as shown in FIG. 2, or asynchronously. For embodiments in which communications are preformed asynchronously, for example, after the integration engine 180 receives the results from the product search request, the integration engine 180 can communication with the services asynchronously and in any sequence to retrieve the information from the services 145, 155, 165, and 175.

FIG. 4 is an exemplary GUI 400 that can be provided by an exemplary embodiment of the user interface 110. The GUI 400 can be programmed and/or configured to facilitate searching for items/products based on search parameters entered by the user (e.g., via text or speech). The GUI 400 can be programmed and/or configured to include data entry fields 402 to receive inputs from the user. For example, a data entry first field 404 can facilitate entry of key terms, second data entry field 406 can facilitate entry of a store identifier (e.g., a store number), and third data entry field 408 can facilitate limiting a quantity of items/products returned by the search (e.g., the top five results based on relevance to the search terms). The data entry fields 402 can be populated via text entry and/or from speech received from a user. As one example, the user can select a button 410 to open a virtual keyboard in the GUI that can be used to type in search parameters via a touch screen display. As another example, the user can select a button 412 to facilitate entry of search parameters through speech via a microphone associated with the device implementing the GUI 400. In exemplary embodiments, the GUI can be displayed on a display user's portable computing device.

Once the user has entered the requested data in the data entry fields 402, the user can select a search button 414 to initiate an embodiment of the product information retrieval process. Results 416 of the search can be displayed in the GUI 400. As shown in FIG. 4, the results 416 can include product information that can be retrieved from disparate data sources and formatted to be displayed in the GUI 400. The product information can include the product specific information 418 (e.g., one or more product images 450, a product description 452, a price 454), the stock room inventory information 420 (e.g., a quantity 456 of the product in the stock room, a location 458 of the product in the stock room), in-store inventory information 422 (e.g., a total quantity 460 of the product in the store), aisle location information 424 (e.g., an aisle number 462 in the store), and logistic information 426 (e.g., an expected next delivery date 464 of the product).

While the present embodiment illustrates various data entry fields for receiving one or more search parameters, those skilled in the art will recognize that the GUI 400 can be programmed and/or configured to provide more, fewer, and/or different data entry fields and that a user can perform a search without entering parameters for all or some of the data entry fields. For example, for embodiments in which the system is operated by an employee of a retail location the store identifier can be prepopulated with the store identifier corresponding the store location at which the user is employed.

FIG. 5 shows an exemplary map 500 that can be displayed to the user to show a user a location at which the products/items returned in the results 416 are in the store location identified in the search parameters. The map 500 can provide the user with an indicator 502 showing a location of the products/items, for example, on a display shelf in the store and/or an indicator 504 showing a location of the products/items, for example, in the stock (back) room of the store location identified in the search parameters.

In some embodiments, the map 500 can be interactive. As one example, the indicators (e.g., indicators 502 and 504) can be selected by the user. In response, to a selection of one of the indicators on the map, product information corresponding to the indicator can be displayed to the user. As another example, the environment 100 can be programmed and/or configured to implement an interactive global positioning system (GPS), position tracking using wireless communication (e.g., via triangulation techniques known to those skilled in the art), and/or any other suitable position tracking techniques to allow the user to determine the user's location relative to the location of the products.

FIG. 6 is a block diagram of an exemplary computing device 600 that may be used to implement exemplary embodiments of the front end reservation system 102 and/or the back end reservation system 104 described herein. The computing device 600 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 606 included in the computing device 600 may store computer-readable and computer-executable instructions or software for implementing exemplary embodiments of the front end reservation system 102 and/or the back end reservation system 104. The computing device 600 also includes configurable and/or programmable processor 602 and associated core 604, and optionally, one or more additional configurable and/or programmable processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ may each be a single core processor or multiple core (604 and 604′) processor.

Virtualization may be employed in the computing device 600 so that infrastructure and resources in the computing device may be shared dynamically. A virtual machine 614 may be provided to handle a process running on multiple processors so that the process appears to be using only one computing resource rather than multiple computing resources. Multiple virtual machines may also be used with one processor.

Memory 606 may include a computer system memory or random access memory, such as DRAM, SRAM, EDO RAM, and the like. Memory 606 may include other types of memory as well, or combinations thereof.

A user may interact with the computing device 600 through a visual display device 618, such as a computer monitor, which may display one or more graphical user interfaces 112 that may be provided in accordance with exemplary embodiments. The computing device 600 may include other I/O devices for receiving input from a user, for example, a keyboard or any suitable multi-point touch interface 608, a pointing device 610 (e.g., a mouse), a microphone 628, and/or an image capturing device 632 (e.g., a camera or scanner). The keyboard 608 and the pointing device 610 may be coupled to the visual display device 618. The computing device 600 may include other suitable conventional I/O peripherals.

The computing device 600 may also include one or more storage devices 624, such as a hard-drive, CD-ROM, or other computer readable media, for storing data and computer-readable instructions and/or software that implement exemplary embodiments of the front end reservation system 102 and/or the back end reservation system 104 described herein. Exemplary storage device 624 may also store one or more databases for storing any suitable information required to implement exemplary embodiments. For example, exemplary storage device 624 can store one or more databases 626 for storing information, such as product information including, for example, product specific information, product inventory information, product location information, and/or any other information to be used by embodiments of the systems 102 and/or 104. The databases may be updated manually or automatically at any suitable time to add, delete, and/or update one or more items in the databases.

The computing device 600 can include a network interface 612 configured to interface via one or more network devices 620 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 400 can include one or more antennas 630 to facilitate wireless communication (e.g., via the network interface) between the computing device 600 and a network. The network interface 612 may include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 600 may run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 616 may be run in native mode or emulated mode. In an exemplary embodiment, the operating system 616 may be run on one or more cloud machine instances.

FIG. 7 is a block diagram of an exemplary client-server environment 700 configured to implement one or more embodiments of the environment 100. The environment 700 includes servers 710-713 operatively coupled to clients 720-722, via a communication network 750, which can be any network over which information can be transmitted between devices communicatively coupled to the network. For example, the communication network 750 can be the Internet, an Intranet, virtual private network (VPN), wide area network (WAN), local area network (LAN), and the like. The environment 700 can include repositories or databases 730-735, which can be operatively coupled to the servers 710-713, as well as to clients 720-722, via the communications network 750. The servers 710-713, clients 720-722, and databases 730-735 can be implemented as computing devices. Those skilled in the art will recognize that the database devices 730-735 can be incorporated into one or more of the servers 710-713 such that one or more of the servers can include databases. In an exemplary embodiment, the front end system 102 can be implemented by the server 710 and the back end system 104 can be implemented by one or more of the server 711-713 and/or databases 730-735. In some embodiments, the front end system 102 and/or the back end system 104 can be distributed over different servers.

The client devices 720-722 can include a client side application 723 programmed and/or configured to access or execute the front end system 102 to search for product/item information. In the present embodiment, the client devices 720-722 can be computing devices including, for example, portable computing devices. In one embodiment, the client-side application 723 implemented by the client device 720 can be a web-browser capable of navigating to one or more web pages hosting GUIs of the environment 100 and the client-side application 723 implemented by the client device 721 can be the front end system 102 itself. For example, in some embodiments, the client-side application 723 implemented by one or more of the client devices 720-722 (e.g., portable computing devices) can be an application specific to the environment 100 installed on the client devices 720-722 to permit access to the front end system 102 of the environment 100 or the application can be the front end system 102. In some embodiments, the application specific to the environment 100 can be a mobile application installed and executed by a portable computing device. In exemplary embodiments, the client devices 720-722 can be configured to communicate with the network 750 via wired and/or wireless communication.

The databases 730-735 can store information for use by the environment 100. For example, the database 730 can store information related to the speech-to-text service, the database 731 can store product specific information including a description of products/items, images of product/items, prices of product/items, and/or product/item identifiers, the database 732 can store stock (back) room inventory and location information corresponding to products/items, the database 733 can store aisle locations of the products/items in the display (front) area of the store, the database 734 can store total in-store inventory information for products/items, and the database 735 can store logistic information for products/items.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. In an electronic commerce environment, a computer-implemented method of providing product information from disparate sources in an integrated graphical format, the method comprising:
receiving an electronic product search request from a user though an electronic device in communication with a data communications network, the product search request including search parameters;
searching a first electronic data source in response to the search request to programmatically identify product specific information that corresponds to one or more products associated with the search parameters in the search request;
programmatically constructing an electronic product inventory search request using the product specific information;
searching a second electronic data source for inventory information of the one or more products in response to the product inventory search request to programmatically identify whether the one or more products are available;
programmatically constructing an electronic product location search request automatically from the product specific information and the inventory information;
searching a third electronic data source for product location information of the one or more products in response to the product inventory search request to programmatically identify a location of the one or more products; and
forwarding instructions and data to a graphical user interface for display by the electronic device having executable code to integrate the product specific information from the first electronic data source, the inventory information from the second electronic data source, and the product location information from the third electronic data source for display by the electronic device.

2. The method of claim 1, wherein receiving the search parameters comprises receiving the search parameters as speech from a user via a microphone of the electronic device, the search parameters being converted from speech to text by a speech-to-text service.

3. The method of claim 1, wherein the product search request corresponds to products associated with a specific retail location of a retail entity.

4. The method of claim 3, wherein searching the second electronic data source for inventory information comprises searching for a total quantity of products available at the specific retail location.

5. The method of claim 4, further comprising:
programmatically constructing an electronic product stock room inventory search request using the product specific information;
searching a fourth electronic data source for stock room inventory information of the one or more products in response to the stock room inventory search request to programmatically identify a quantity of the one or more products being stored in a stock room of the specific retail location and a location of the one or more products in the stock room.

6. The method of claim 1, wherein the product specific information comprises a description of each of the one or more products, at least one image of each of the one or more products, a price for each of the one or more products, and a product identifier associated with each of the one or more products.

7. The method of claim 6, wherein programmatically constructing the electronic product inventory search request using the product specific information comprising constructing the electronic product inventory search request to programmatically include the product identifier returned in response to the electronic product search request.

8. The method of claim 1, wherein the product location information comprises an aisle location of each of the one or more products.

9. The method of claim 1, further comprising providing a map for display by the electronic device, the map corresponding to a layout of a specific retail location and including at least one indicator to mark a location of the one or more products in the specific retail location.

10. The method of claim 9, wherein the map is an interactive map and the method comprises providing a relative location of the electronic device with respect to the location of the one or more products.

11. The method of claim 1, further comprising:
programmatically constructing an electronic product logistic information request automatically based on the product specific information and the inventory information; and
searching a fourth electronic data source for logistic information associated with the one or more products in response to the product logistic information request to programmatically identify logistic information associated with the one or more products.

12. A non-transitory computer-readable storage device configured to store instructions executable by a processing device, wherein execution of the instructions in an electronic product information retrieval environment causes the processing device to implement a method of retrieving product information from disparate sources comprising:
reading instructions to receive an electronic product search request from a user though an electronic device in communication with a data communications network, the product search request including search parameters;
reading instructions to search a first electronic data source in response to the search request to programmatically identify product specific information that corresponds to one or more products associated with the search parameters in the search request;
reading instructions to programmatically construct an electronic product inventory search request using the product specific information;
reading instructions to search a second electronic data source for inventory information of the one or more products in response to the product inventory search request to programmatically identify whether the one or more products are available;
reading instructions to programmatically construct an electronic product location search request from the product specific information and the inventory information;
reading instructions to search a third electronic data source for product location information of the one or more products in response to the product inventory search request to programmatically identify a location of the one or more products; and
reading instructions to forward instructions and data to a graphical user interface for display by the electronic device having executable code to integrate the product specific information from the first electronic data source, the inventory information from the second electronic data source, and the product location information from the third electronic data source for display by the electronic device.

13. The non-transitory storage device of claim 12, wherein the search parameters are received as speech from a user via a microphone of the electronic device and the search parameters are converted from speech to text by a speech-to-text service.

14. The non-transitory storage device of claim 12, wherein the product search request corresponds to products associated with a specific retail location of a retail entity and reading instructions to search the second electronic data source for inventory information comprises reading instructions to search for a total quantity of products available at the specific retail location.

15. The non-transitory storage device of claim 14, wherein the method implemented upon execution of the instructions by the processing device further comprises:
reading instructions to programmatically construct an electronic product stock room inventory search request using the product specific information;
reading instructions to search a fourth electronic data source for stock room inventory information of the one or more products in response to the stock room inventory search request to programmatically identify a quantity of the one or more products being stored in a stock room of the specific retail location and a location of the one or more products in the stock room.

16. The non-transitory storage device of claim 12, wherein the product specific information comprises a description of each of the one or more products, at least one image of each of the one or more products, a price for each of the one or more products, and a product identifier associated with each of the one or more products, and reading instructions to construct the electronic product inventory search request comprises constructing the electronic product inventory search request to programmatically include the product identifier returned in response to the electronic product search request.

17. The non-transitory storage device of claim 12, wherein the method implemented upon execution of the instructions by the processing device further comprises comprising providing a map for display by the electronic device, the map corresponding to a layout of a specific retail location and including at least one indicator to mark a location of the one or more products in the specific retail location.

18. An electronic commerce system for providing product information from disparate sources in an integrated graphical format comprising:
a non-transitory storage device storing in instructions for a front end product information retrieval system; and
a processing device in communication with the non-transitory storage device to execute the instructions to:
receive an electronic product search request from a user though an electronic device in communication with a data communications network, the product search request including search parameters;
programmatically submit the electronic product search request to a product search service;
receive product specific information that corresponds to one or more products associated with the search parameters in the search request, the product specific information being retrieved in response to searching a first electronic data source;
programmatically construct an electronic inventory search request using the product specific information;
programmatically submit the electronic inventory search request to an inventory retrieval service;
receive inventory information in response to the electronic inventory search request that corresponds to one or more products and identifies whether the one or more products are available, the inventory information being retrieved in response to searching of a second electronic data source;
programmatically construct an electronic product location search request from the product specific information and the inventory information;
programmatically submit the electronic product location search request to an product location service;
receive product location information of the one or more products in response the electronic product location search request, the product location information being retrieved in response to searching a third electronic data source; and
forward instructions and data to a graphical user interface for display by the electronic device having executable code to integrate the product specific information from the first electronic data source, the inventory information from the second electronic data source, and the product location information from the third electronic data source for display by the electronic device.

19. The system of claim 18, wherein the product search request corresponds to products associated with a specific retail location of a retail entity and the electronic inventory search request requests a search for a total quantity of products available at the specific retail location.

20. The system of claim 19, wherein the processing device is programmed to execute the instructions to:
programmatically construct an electronic product stock room inventory search request using the product specific information;
programmatically submit the stock room inventory search request to a stock room inventory service;
receive stock room inventory information of the one or more products in response to the stock room inventory search request, the stock room inventory information being retrieved in response to searching a fourth electronic data source, the stock room inventory information including a quantity of the one or more products being stored in a stock room of the specific retail location and a location of the one or more products in the stock room.

21. The system of claim 18, wherein the processing device is programmed to execute the instructions to provide a map for display by the electronic device, the map corresponding to a layout of a specific retail location and including at least one indicator to mark a location of the one or more products in the specific retail location.

22. A computer-implemented method comprising:
providing a downloadable user interface executable on a portable electronic device that:
receives an electronic product search request from a user though an electronic device in communication with a data communications network, the product search request including search parameters;
programmatically submits the electronic product search request to a product search service;
receives product specific information that corresponds to one or more products associated with the search parameters in the search request, the product specific information being retrieved in response to searching a first electronic data source;
programmatically constructs an electronic inventory search request using the product specific information;
programmatically submits the electronic inventory search request to an inventory retrieval service;
receives inventory information in response to the electronic inventory search request that corresponds to one or more products and identifies whether the one or more products are available, the inventory information being retrieved in response to searching of a second electronic data source;
programmatically constructs an electronic product location search request from the product specific information and the inventory information;
programmatically submits the electronic product location search request to an product location service;
receives product location information of the one or more products in response the electronic product location search request, the product location information being retrieved in response to searching a third electronic data source; and
forwards instructions and data to a graphical user interface for display by the electronic device having executable code to integrate the product specific information from the first electronic data source, the inventory information from the second electronic data source, and the product location information from the third electronic data source for display by the portable electronic device.
